(19) United States
(12) Patent Application Publication
(10) Pub. No.: US 2012/0265831 A1
(43) Pub. Date: Oct. 18, 2012

(54) System and Method for Transmitting and Filtering Instant Messaging Information

(75) Inventor: Xueqin Sun, Hangzhou (CN)

(73) Assignee: ALIBABA GROUP HOLDING LIMITED, Grand Cayman (KY)

(21) Appl. No.: 13/518,129

(22) PCT Filed: Jan. 13, 2012
(86) PCT No.: PCT/US12/21326

§ 371 Date: Jun. 21, 2012

(30) Foreign Application Priority Data
Jan. 17, 2011 (CN) 201110009879.2

(51) Int. Cl. G06F 15/16

(52) U.S. Cl. 709/206

(57) ABSTRACT

The present disclosure provides a method, a system and a device of transmitting instant messaging information. The techniques use at least two determinations. A first determination evaluates whether a first user identification of a sender of the instant messaging information is identified as a high priority user associated with a second user identification of a receiver. A second determination ascertains whether operation information relating the second user identification corresponding to the first user identification is stored. When the result of the first determination is negative, the instant messaging information is not directly treated as instant messaging information. The result of the second determination may be used to determine whether the instant messaging information is junk information. The techniques, when achieving the purpose of filtering junk information, reduce the possibility that the valid information is treated as junk information, and improve the accuracy of filtering junk information.

### CROSS REFERENCE TO RELATED PATENT APPLICATIONS

This application is a national stage application of an international patent application PCT/US12/21326, filed Jan. 13, 2012, which claims priority to Chinese Patent Application No. 201110009879.2 filed on Jan. 17, 2011, entitled “Method, System and Device for Instant Messaging Information,” which applications are hereby incorporated by reference in their entirety.

### TECHNICAL FIELD

The present disclosure relates to the field of communication and, more specifically, to a method, a system, and a device of transmitting instant messaging information.

### BACKGROUND

With the increase of instant messaging users, the security of instant messaging becomes an important issue. For example, junk information (including the advertisement information, solicitation information, malicious information) needs to be removed immediately.

To shield the users from the junk information contained in the instant messaging information, current techniques usually block all temporary conversation information. In other words, the server of the instant messaging business stores the priorities of each of the other clients defined by the instant messaging client in advance. When the server receives the instant messaging information, it determines whether the information is sent by a sender who is a high priority user (including a legitimate user defined as a friend) defined by the receiver according to the information of the sender and the receiver. If the sender is a high priority user of the receiver, the server sends the instant messaging information to the receiver and requests the receiver to display the instant messaging information. Otherwise (for example, the sender is a low priority user such as a stranger defined by the receiver) the server treats the instant messaging information as junk information and refuses to send the instant messaging information to the receiver.

The above techniques may filter junk information effectively. However, the server blocks all instant messaging information sent from any users other than the high priority users defined by the receiver. Some information sender and receiver may have certain relationships although the sender is not a high priority user defined by the receiver. The current techniques may also filter such valid information. For example, in a scenario where the instant messaging information is used for e-business transaction, the buyer does not define the seller as a high priority user but the instant messaging information sent by the seller to the buyer is not necessarily junk information if there is a transaction between them. The instant messaging information sent by the seller to the buyer will be filtered under the current techniques, and consequently the normal communication and the transaction between the seller and the buyer cannot be completed.

### SUMMARY

The present disclosure provides techniques for transmitting instant messaging information that solve the problems of the current techniques that filter not only junk information but also non-junk information by mistake.

The present disclosure provides a method for transmitting instant messaging information. The instant messaging information includes a first user identification of a sender and a second user identification of a receiver. It is first determined whether the first user identification is an identification of a high priority user associated with the second user identification. If a result of the first determination is negative, a second determination is performed to determine whether operation information relating the second user identification to the first user identification is stored. Filtering of the instant messaging information is dependent upon a result of the second determination.

The present disclosure also provides a server for transmitting instant messaging information. The server includes a receiving module, a first determination module, a second determination module, and an execution module. The receiving module receives the instant messaging information including the first user identification of the sender and the second user identification of the receiver. The first determination module determines whether the first user identification is an identification of a high priority user associated with the second user identification and triggers the second determination module if the result of the first determination is negative. The second determination module determines whether operation information relating the second user identification to the first user identification is stored. The execution module determines whether to filter the instant messaging information depending upon the result of the second determination module.

The present disclosure also provides a system for transmitting instant messaging information. The system includes a client logged onto by the sender (a sender client), a server, and a client logged onto by the receiver (a receiver client). The sender client sends the instant messaging information.

The server receives the instant messaging information including the first user identification of the sender and the second user identification of the receiver. The server firstly determines whether the first user identification is an identification of a high priority user of the second user identification. If the result of the first determination is negative, the server secondly determines whether operation information relating the second user identification to the first user identification is stored, and further determines whether to filter the instant messaging information dependent upon the result of the second determination. The receiver client displays or filters the instant messaging information after receiving the instant messaging information.

There are many advantages of the techniques provided by the present disclosure. The present disclosure determines whether the instant messaging information is junk information by determining whether the first user identification sent by the sender of the instant messaging information is the identification of the high priority user of the second user identification of the receiver, and determining whether operation information relating the second user identification to the first user identification is stored. When the first user identification is not the identification of the high priority user of the second user identification, the instant messaging information sent by the sender is not directly treated as junk information. The operation information is used in the second determination and the result of the second determination is used to determine whether the instant messaging information is junk information. The techniques, when achieving the purpose of filtering junk information, may reduce the possibility that valid information being treated as junk information and thereby increase the accuracy of filtering junk information.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure. A person of ordinary skill in the art can obtain other figures according to the figures in the present disclosure without creative efforts.

FIG. 1A and FIG. 1B illustrate flowcharts of example methods for transmitting instant messaging information in accordance with a first example embodiment of the present disclosure.

FIG. 2 illustrates a diagram of example transmission of the instant messaging information between an instant messaging client A and an instant messaging client B in accordance with a second example embodiment of the present disclosure.

FIG. 3 illustrates a diagram of example transmission of the instant messaging information between the instant messaging client A and an instant messaging client C in accordance with the second example embodiment of the present disclosure.

FIG. 4 illustrates a diagram of example transmission of the instant messaging information between the instant messaging client A and an instant messaging client D in accordance with the second example embodiment of the present disclosure.

FIG. 5 illustrates a structure diagram of an example system for transmitting instant messaging information in accordance with a third example embodiment of the present disclosure.

FIG. 6 illustrates a structure diagram of an example server for transmitting instant messaging information in accordance with a fourth example embodiment of the present disclosure.

### DETAILED DESCRIPTION

In order to filter the junk information in the instant messaging information and prevent filtering valid information in the instant messaging information by mistakes, the present disclosure determines whether the instant messaging information is junk information according to not only the priority of the sender defined by the receiver. Instead, the present disclosure determines whether operation information relating the second user identification of the receiver to the first user identification of the sender is stored, and uses the result to determine whether the information is junk information. If the operation information relating the second user identification to the first user identification is stored, it is considered a certification from the receiver to the sender to certain extent. Therefore, the instant messaging information sent by the sender is not determined as junk information directly. The receiver receives the instant messaging information and displays it to prevent the valid information from being misjudged as junk information. If the operation information relating the second user identification to the first user identification is not stored, the instant messaging information sent by the sender can be determined as junk information and the receiver can filter the instant messaging information.

In the present disclosure, the receiver client is the client on which the receiver of the instant messaging information is logged, and the sender client is the client on which the sender of the instant messaging information is logged. After a user of instant messaging logs onto a client, when the client receives the instant messaging information, such client is the receiver client; when the client sends the instant messaging information, such client is the sender client.

The first user identification represents the sender. In other words, the sender can log onto the instant messaging client from different client terminals. No matter from which client terminal the sender logs onto, the sender can be determined according to the first user identification.

The second user identification represents the receiver. In other words, the receiver can log onto the instant messaging client from different client terminals. No matter from which client terminal the receiver logs onto, the receiver can be determined according to the second user identification.

The operation information includes the information representing indirect operation from the second user identification to the first user identification. The operation information includes, but is not limited to, the following information:

1. Visiting record information of the second user identification visiting a document, such as a web page, corresponding to the first user identification. In other words, after the receiver logs onto the client terminal, the receiver performs operations such as visiting a web page corresponding to the sender client.

2. Transaction record information between the second user identification and the first user identification. In other words, the sender and receiver conduct the online transaction.

The operation information may be presented in many ways. For example, the operation information may be represented by a flag bit. When the flag bit is not zero, it indicates that the corresponding operation information exists. When the flag bit is zero or does not exist, it indicates that no corresponding operation information exists.

The operation information may also include operation time and valid period. The operation time refers to the time that the receiver client starts to conduct the operation to the sender client. The valid period refers to a valid period of time of the operation information. The valid period may start from the operation time. After the valid period, the operation information is invalid or deleted.

The operation information does not include the direct instant messaging information transmission between the sender client and the receiver client, such as the record that the sender client sends the instant messaging information to the receiver client.

The operation information may be stored in a server. When the user logs onto the client terminal, the operation (such as visiting web page and making transaction) are recorded and updated by the server at real-time.

In one embodiment, when the user logs onto the client terminal, the prior operation information, which was generated when the user previously logged onto to the client terminal or another client terminal, may be downloaded from the server based on the unique identification of the user. Alternatively, the operation information generated after the user logs onto the client terminal may be stored in a local memory.

The instant messaging information may be information containing texts and pictures, information enclosing documents, or a request for conducting communications with the receiver, e.g., in the form of audio or video.

The server is the equipment that provides services to the instant messaging business. The server is capable of receiving and transferring the instant messaging information among client terminals, and recording and updating operation information.

The following illustrates a first example embodiment.

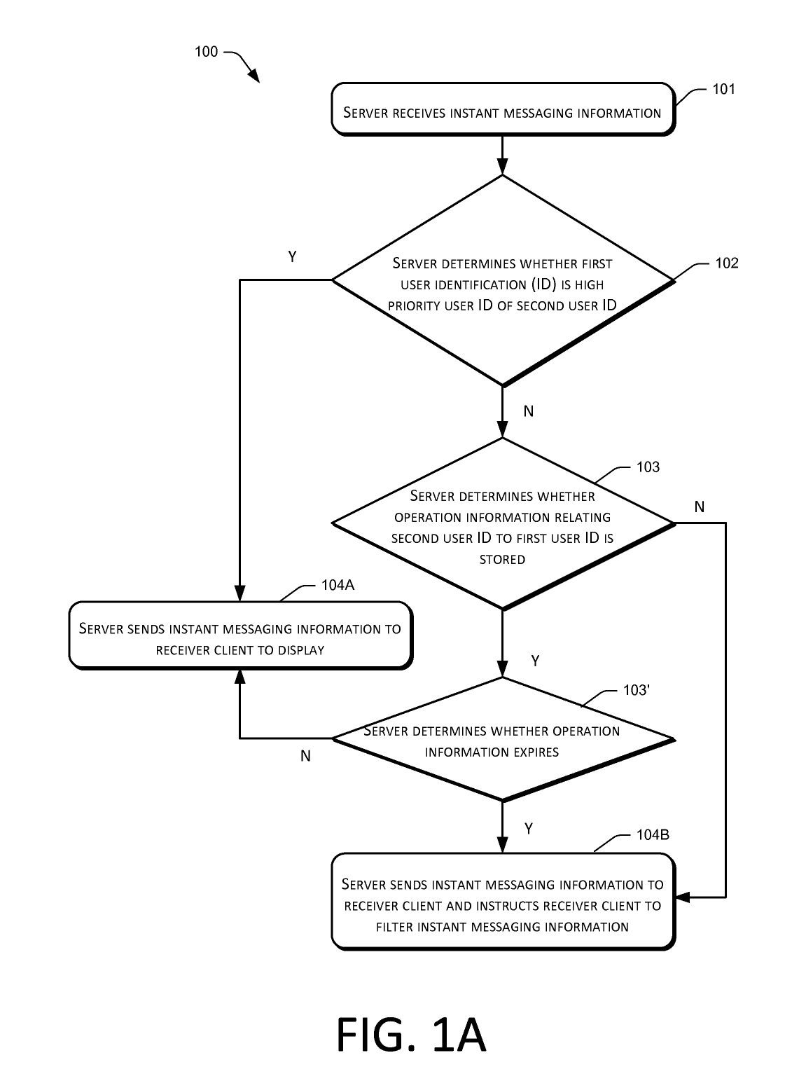

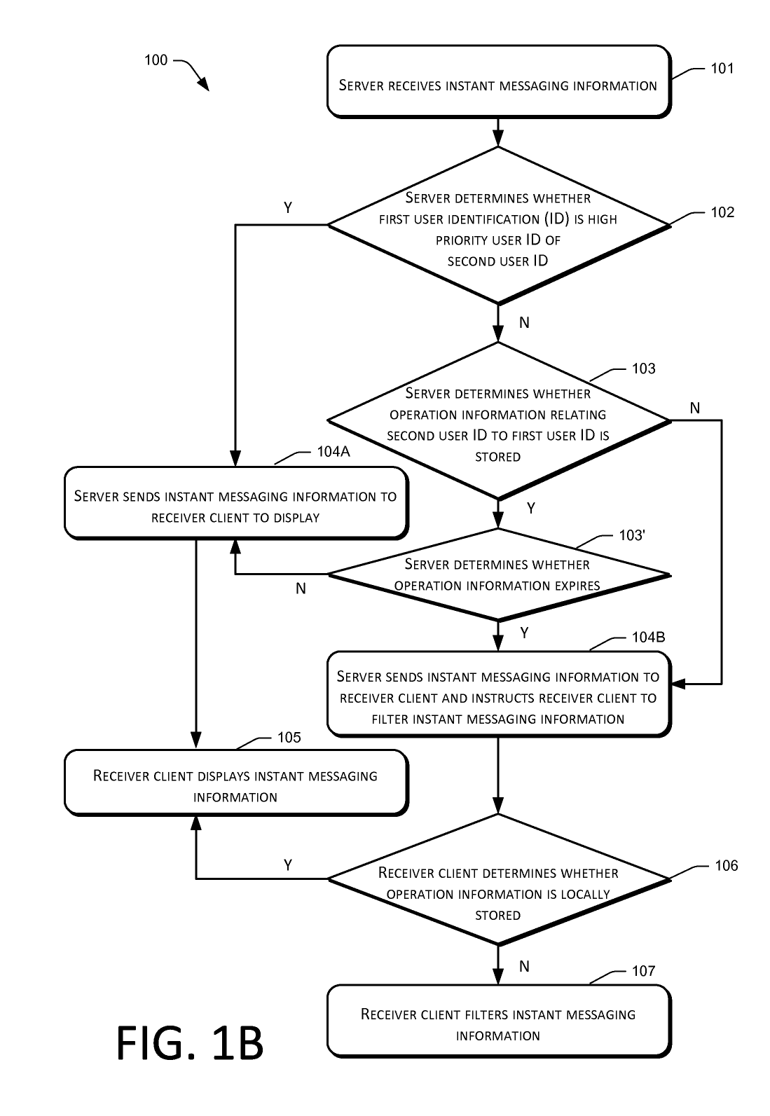

FIG. 1A illustrates an example process 100 for transmitting instant messaging information in accordance with the first example embodiment of the present disclosure. The process 100 includes the following operations.

At 101, the server receives instant messaging information. More particularly, in one implementation, the sender logs onto the client terminal of the instant messaging and sends the instant messaging information to the receiver client logged onto by the receiver. The instant messaging information may be transmitted to the server before it reaches the receiver client. The instant messaging information includes a first user identification of the sender and a second user identification of the receiver. The first user identification is information that may represent the sender, such as the user name of the sender. The second user identification is information that may represent the receiver, such as the user name of the receiver. The sender client is the client terminal corresponding to the first user identification of the sender. The receiver client is the client terminal corresponding to the second user identification of the receiver.

At 102, the server determines whether the first user identification is an identification of a high priority user associated with the second user identification. If the result of this determination is positive (i.e., the “Y” branch from 102), the server sends the instant messaging information to the receiver client to display at 104A. Otherwise (i.e., the “N” branch from 102), operations 103 is performed, as described below in more detail.

The determination at 102 is the first determination performed by the server to ascertain whether the sender client is a legitimate user to the receiver client. For example, the receiver logs onto the client and defines the sender as the high priority user (such as a friend). Both the server and the receiver client record this event of defining a friend. In other words, the first user identification is recorded in the high priority user group (such as a contact list) of the second user identification to indicate that the sender corresponding to the first user identification is a legitimate user of the receiver corresponding to the second user identification.

After receiving the instant messaging information, the server searches whether the first user identification exists in the high priority user group of the second user identification. If the search result is positive, the server determines that the sender is a legitimate user defined by the receiver and the instant messaging information sent by the sender is legitimate information. Otherwise, it determines that the sender is not considered a high priority user (such as a stranger) and its legitimacy is uncertain, and the legitimacy of the instant messaging information sent by the sender is uncertain too.

In addition to determining whether the sender is the legitimate user by checking if the sender is defined as the legitimate user, some other operations may be combined to perform the first determination. For example, the server may check whether the receiver client conducts any direct operation to the sender client to determine if the sender is the legitimate user of the receiver.

For instance, the receiver client is assumed to be Client 2 and the sender client is assumed to be Client 1. There is no defined friend relationship between the Client 1 and Client 2. When the Client 2 initiates communication (such as sending instant messaging information) with the Client 1, the server stores this event. Afterwards, when the Client 1 conducts the operation at 101 to the Client 2, the server determines that the first user identification is the identification of the high priority user of the second user identification as Client 2 previously initiated communication with the Client 1. In other words, the sender is the legitimate user to the receiver.

At 103, the server determines whether operation information relating the second user identification to the first user identification is stored. This determination is the second determination performed by the server. The second determination is used to ascertain the legitimacy of the sender when the sender is not determined as a legitimate user defined by the receiver.

In one embodiment, when a user logs onto a client terminal to conduct some indirect operations to another client terminal logged onto by another user, the corresponding operation information can be recorded in the server. For example, a user 1 uses a user identification 1 to log onto as the Client 1 to conduct indirect operations to a Client 2 that is logged onto by a user 2 using a user identification 2. The server records the operation information as follows:

### Example 1

When the Client 2 accesses or visits the web page provided by the Client 1 at time T1, the server records the corresponding operation information. The operation information may include the record that the user identification 2 accesses or visits the page corresponding to the user identification 1. The operation information may also include the operation time T1 that the Client 2 conducts operations to the Client 1.

### Example 2

When the Client 1 and the Client 2 conduct an online transaction at time T2, the server records the corresponding operation information. The operation information may include the record that the user identification 2 conducts transaction with the user identification 1. The operation information may also include the operation time T2 that the Client 2 conducts transaction with the Client 1.

The server may store the operation information in a table. Each item of the table represents a piece of operation information. The operation information generated by operations made by one user identification to other user identifications may be placed together.

The server may search the operation information table according to the first user identification and the second user identification contained in the received instant messaging information to determine whether the table stores the operation information relating the second user identification to the first user identification. In other words, it is determined whether there are operation information records made by the second user identification to the first user identification. If the result of determination is positive, it indicates that the receiver conducts operations to the sender; otherwise, it indicates that the receiver does not conduct operations to the sender.

A user may log onto the client from different client terminals. No matter where the user logs onto the client terminal, as long as the user has relevant operations to another user, such as accessing corresponding pages or transactions, the operation information that relate the user identification to another user identification is recorded.

The server then sends the instant messaging information to the receiver client and determines whether to filter the instant messaging information based on the result of determination at 103. At 104A, the server sends the instant messaging information to the receiver client and instructs the receiver client to display the instant messaging information. At 104B, the server sends the instant messaging information to the receiver client and instructs the receiver client to filter the instant messaging information.

There are two possible results of determination at 103. One is that the server stores the operation information relating the second user identification to the first user identification, and the other is that the server does not store the operation information. Based on the result of determination, the instructions that the server sends the instant messaging information to the receiver client vary. When the result of determination is that the server stores the operation information relating the second user identification to the first user identification, the server instructs the receiver client to display the instant messaging information; otherwise, the server instructs the receiver client to filter the instant messaging information.

In this embodiment, in order to prevent the valid information from being filtered by mistakes, when the server determines that the operation information relating the second user identification to the first user identification is not stored, it considers that the information sent by the sender may be junk information but does not filter the instant messaging information directly. Instead, it sends the instant messaging information to the receiver client and also sends the determination result at 103 to the receiver client, and instructs the receiver client to display or filter the instant messaging information based on the determination result.

The techniques through operations at 101-104 under the first example embodiment do not use the priority of the sender client defined by the receiver client as the only basis to determine junk information. Instead, the techniques also use operation information between corresponding users as the determination basis. When there does not exist the operation information relating the user identification of the sender to the user identification of the receiver, the instant messaging information sent by the sender may be deemed as junk information. The server may send the instant messaging information to the receiver client and instruct the receiver client to filter the information.

When there is operation information relating the user identification of the sender to the user identification of the receiver, it may be deemed that the receiver client recognizes the instant messaging information sent by the sender client. The server may send the instant messaging information to the receiver and instruct the receiver client to display the information. This avoids the problem that the valid information is filtered by mistake when the receiver client does not define the sender client as the high priority user.

While operations at 101-104 provide one implementation, there may be alternative implementations that involve additional or different operations. A few example alternative implementations to the first example embodiment are described below in more detail.

At 103, the server may use the operation information relating the user identification of the sender to the identification of the receiver as the determination basis. In addition, there may also operations to update the operation information based on their valid periods. For example, different valid periods may be set for different operation information. After the expiration of corresponding valid period, the operation information expires. For example, the operation information may be deleted or set as invalid.

When the sender client sends the instant messaging information to the receiver client, it is determined whether the stored operation information relating the sender to the receiver is valid. In an event that the operation information relating the sender to the receiver is within the valid period, it is permitted that the sender client sends the instant messaging information to the receiver client. In an event that the valid period expires, the instant messaging information sent by the sender client to the receiver client is filtered.

Thus between the operations at 103 and the operations at 104, there might be other operations.

For example, at 103′, after the operation information relating the second user identification to the first user identification is stored, the server determines whether the operation information expires. If the determination result is positive, the server sends the instant messaging information to the client corresponding to the second user identification and instructs the client to filter the instant messaging information. Otherwise, the server sends to the instant messaging information to the client corresponding to the second user identification and instructs the client to display the instant messaging information.

For example, the techniques may apply to a scenario of using the instant messaging information to aid the online transaction. The receiver is the buyer and the sender is the seller. When the client is logged onto by the buyer (buyer client) that visits the web page provided by the seller, the server and/or the buyer client may store the operation information relating the user identification of the buyer to the user identification of the seller. If the operation information is within its valid period, the server, after receiving the instant messaging information sent by the client logged onto by the seller (seller client) to the buyer client, does not recognize the instant messaging information sent by the seller client as junk information. The server sends the instant messaging information to the buyer client, and instructs the buyer client to display the instant messaging information to the buyer.

If the buyer client did not previously visit the web page provided by the seller, or, although the buyer client previously visited the web page, the buyer client sends the instant messaging information to the seller client after the valid period, the instant messaging information sent by the seller client is deemed as junk information. The server sends the instant messaging information to the buyer client, and instructs the buyer client to filter the instant messaging information.

FIG. 1B shows another alternative implementation in which the process in FIG. 1B is enhanced with additional operations at 105-107. As shown in FIG. 1B, after the receiver client receives the instant messaging information and the instruction determined based on the result sent by the server, the instant messaging information may be displayed at 104A or filtered at 104B according to the server's instruction. For example, before displaying or filtering the instant messaging information, the receiver client may further determine whether the instant messaging information is junk information. Therefore, there may be further operations after 104.

At 105, one additional operation may be that the receiver client displays the instant messaging information. This operation may be reached as a result of the server identifying the receiver as a high priority user at 102, or the server determining that operation information between sender and receiver is stored and valid at 103 and/or 103′. Therefore, after the receiver client receives the instruction from the server to display the instant messaging information, it trusts that the instant messaging information as junk information and displays it normally.

Another example operation that might be added is to check at the receiver client whether the operation information exists, in the event that the server does not store the operation information or the operation information expires. Thus, at 106, the receiver client determines whether the operation relating the second user identification to the first user identification is locally stored. If the determination result is positive (i.e., the “Y” branch at 106), the instant messaging information is displayed at 105. Otherwise, at 107, the instant messaging information is filtered. Thus, the client may make further determination of the instant messaging information to prevent the filtering by mistake.

In some instances, the receiver client does not treat the instant messaging information according to the server's instruction. For example, the server determines that the instant messaging information is junk information and instructs the receiver client to filter the information, but the receiver client trusts the information and displays the instant messaging information. The server may update its stored operation information based on the display operation of the instant messaging information conducted by the receiver client, and update the operation time to the current time, and re-calculate the valid period of the operation information.

In an example of 103, if the server makes determination based on the condition that the receiver client does not perform any operation to the instant messaging information sent by the sender client during the valid period, and sends filtering instruction to the receiver client, there may be two scenarios.

In a first scenario, after the valid period, the operation information relating the second user identification to the first user identification is generated. Thus the receiver client may ignore the filtering instruction and display the instant messaging information.

In a second scenario, the operation information relating the second user identification corresponding to the first user identification has never been generated. Thus the receiver client recognizes the instant messaging information as junk information and filters it.

The above illustration shows that, based on the first example embodiment, both the server and the receiver client determine whether the instant messaging information is junk information. For example, the determination conditions at the server may be set stricter than those at the receiver client. When the server determines that the instant messaging information is junk information, the receiver client may further determine to avoid filtering by mistake.

The techniques in the first example embodiment may be used in multiple instant messaging scenarios. The second example embodiment illustrates the techniques in the first example embodiment in the scenario of online transaction by using instant messaging as assistance to the business.

The second example embodiment will now be discussed in the context of an online shopping session. Suppose that there are four instant messaging clients A, B, C, and D. During the online shopping session, one buyer logs onto the instant messaging client A, and three sellers, e.g., seller 1, seller 2, seller 3, log onto respective instant messaging clients B, C and D.

Now consider three different relationships among the buyer and three sellers. The buyer previously used the instant messaging client A to access or visit the page provided by the seller 1. The buyer uses the instant messaging client A to define the instant messaging client C logged onto by the seller 2 as a friend. The buyer never uses the instant messaging client A to conduct any operation to the instant messaging client D.

The operation information, the operation time, and the valid period of different operations relating the buyer user identification to the seller 1 user identification, the seller 2 user identification, and the seller 3 user identification may be stored at the instant messaging client A locally and/or the server. If the seller user identification has sub-account identifications associated with the seller user identification, the sub-account identification may also be set to adopt the same method for processing the instant messaging information determination as the seller user identification.

In the example scenario, the communication between the instant messaging client A and the instant messaging clients B, C, and D are illustrated as the follows.

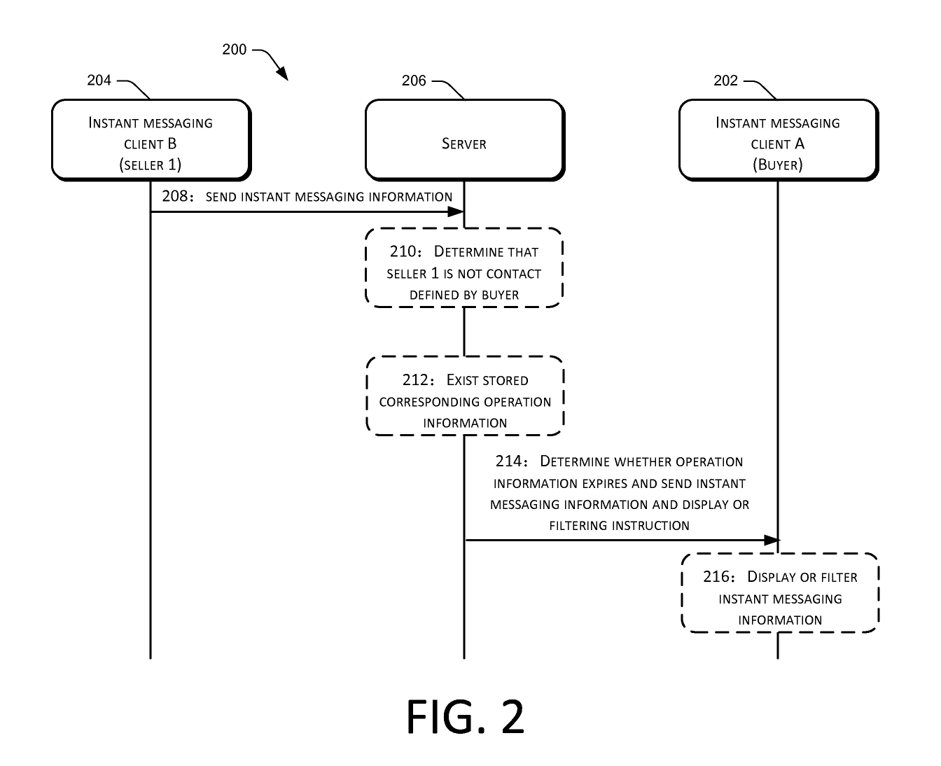

FIG. 2 illustrates transmission flow 200 of the instant messaging information between the instant messaging client A (i.e., 202) and the instant messaging client B (i.e., 204) through a server 206 in accordance with a second example embodiment of the present disclosure. This illustration represents the situation where the buyer has accessed or visited the page of seller 1.

At 208, the server 204 receives the instant messaging information sent by the instant messaging client B logged onto by the seller 1. The instant message is intended for the instant messaging client A logged onto by the buyer.

At 210, the server determines that the seller 1 is not a contact defined by the buyer.

At 212, the server searches the operation information and determines that there exists the operation information relating the identification of the buyer to the identification of the seller 1. For example, the identification of the buyer visited the web page provided by the identification of the seller 1. In other words, the operation information relating the identification of the buyer to the identification of the seller 1 is stored.

At 214, the server determines whether the operation information expires. If the determination result is negative, the server sends the instant messaging information and the display instruction to the instant messaging client A. If the determination result is positive, the server sends the instant messaging information and the filtering instruction to the instant messaging client A.

In the online transaction business, after the buyer purchases some products from the seller, the buyer may communicate with the seller to discuss certain issues such as after-sale service. In one embodiment, even though the instant messaging client A logged onto by the buyer does not define the instant messaging client B logged onto by the seller 1 as a friend, the information sent by the instant messaging client B is not directly considered as junk information. Instead, a valid period with certain length is provided so that the seller 1 may send information to the instant messaging client A through the instant messaging client B during the valid period. Thus, the valid information sent by the seller 1 to the buyer will not be misjudged as junk information.

At 216, when the instant messaging client A receives the display instruction, it displays the instant messaging information. When the instant messaging client A receives the filtering instruction, based on the stored operation information relating the identification of the buyer to the identification of the seller 1, it determines that the buyer previously visited the web page provided by the seller 1. Thus, it does not filter the instant messaging information and displays the instant messaging information.

If at 216 the instant messaging client A filters the instant messaging information, the instant messaging client A feedbacks the information of the filtering event to the server. The server may notify the instant messaging client B according to the notification of the filter event. The user identification of the instant messaging client B may request the user identification corresponding to the instant messaging client A to define it as a friend before re-sending the information.

Alternatively at 216, after receiving the filter instruction, the instant messaging client A may also filter the instant messaging information directly according to the filter instruction.

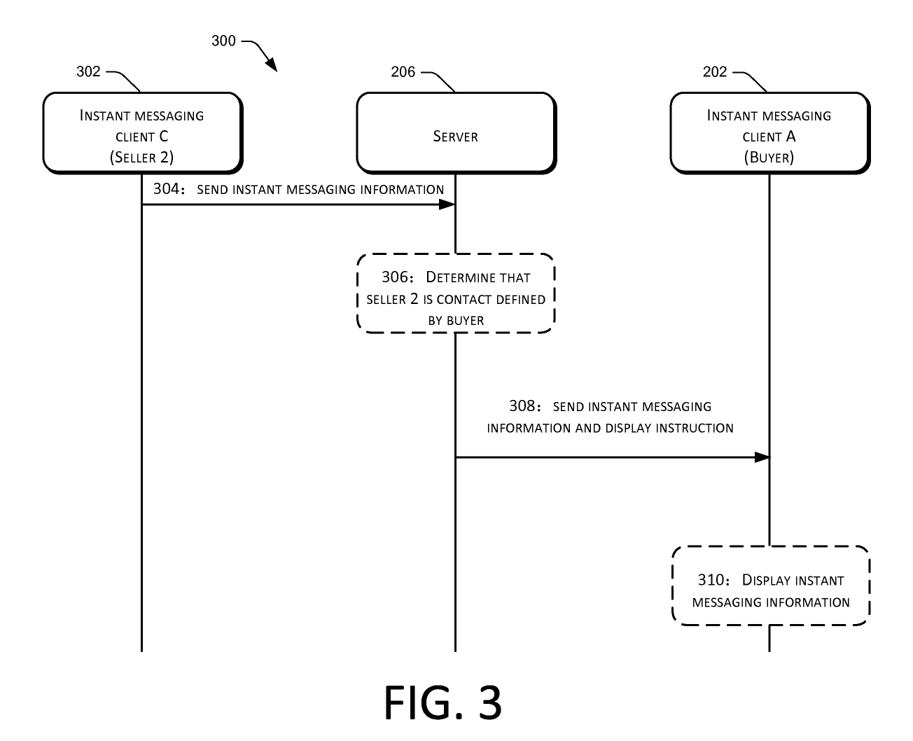

FIG. 3 illustrates transmission flow 300 of the instant messaging information between the instant messaging client A (i.e., 202) and the instant messaging client C (i.e., 302) through server 206. This illustration represents the situation where the buyer has defined seller 2 as a friend.

At 304, the server receives the instant messaging information sent by the instant messaging client C logged onto by the seller 2. The instant message is intended for the instant messaging client A.

At 306, the server determines that seller 2 is a contact defined by the buyer by searching the contact information.

At 308, the server sends the instant messaging information and the display instruction to the instant messaging client A.

At 310, when the instant messaging client A receives the display instruction, it displays the instant messaging information.

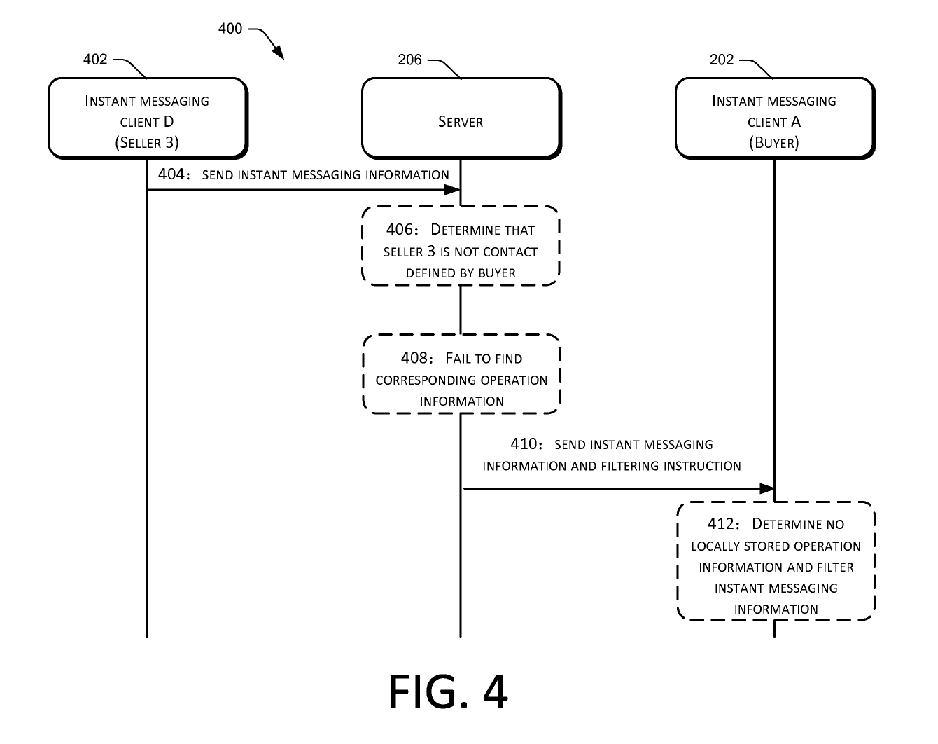

FIG. 4 illustrates transmission flow 400 of the instant messaging information between the instant messaging client A (i.e., 202) and the instant messaging client D (i.e., 402) via the server 206. This illustration represents the situation where the buyer and seller have no relationship.

At 404, the server receives the instant messaging information sent by the instant messaging client D logged onto by the seller 3. The instant message is intended for the instant messaging client A.

At 406, the server determines that seller 2 is not a contact defined by the buyer.

At 408, the server searches the operation information and fails to find the operation information relating the identification of the buyer to the identification of the seller 3 and determines that the instant messaging client A logged onto by the user is not related to the instant messaging client D logged onto by the seller 3.

At 410, the server sends the instant messaging information and the filtering instruction to the instant messaging client A.

At 412, when the instant messaging client A receives the filtering instruction, it further determines whether the client A stores the operation information relating the identification of the user to the identification of the seller 3. If there is no such stored operation information, the instant messaging information is filtered.

As described in the three scenarios of transmitting the instant messaging information of the example second embodiment, the techniques of the present disclosure can be effectively used in assisting the online shopping business. The buyer can not only block junk information from the seller but also prevent the instant messaging information sent by the seller who is related to the buyer from being filtered. The instant messaging clients logged onto by the seller and the buyer may freely select whether to conduct transmission of the instant messaging information in accordance with the techniques under the first example embodiment or the second example embodiment. For example, when the seller may need to receive the instant messaging information passively for selling products, the seller may receive all instant messaging information without adopting some or all of the above techniques.

The following illustrates a third example embodiment.

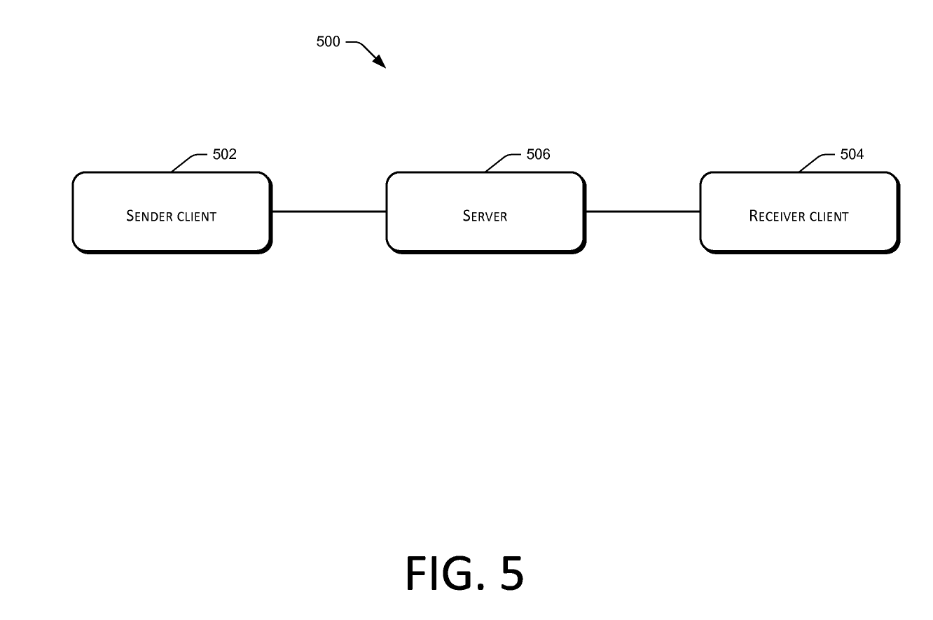

FIG. 5 illustrates an example system 500 for transmitting instant messaging information in accordance with the third example embodiment.

The system 500 includes a client 502 logged onto by the sender (sender client 502), a client 504 logged onto by the receiver (receiver client 504), and a server 506.

The sender client 502 sends the instant messaging information.

The server 506 receives the instant messaging information including a first user identification of the sender and a second user identification of the receiver, and determines whether the first user identification is an identification of a high priority user of the second user identification. If the result of determination is negative, the server further determines whether the server stores operation information relating the second user identification to the first user identification, and determines whether to filter the instant messaging information according to the result of further determination.

The receiver client 504 receives the instant messaging information, and displays or filters the instant messaging information. For example, the receiver client 504 displays the instant messaging information after receiving an instruction of displaying the instant messaging information. After receiving an instruction of filtering said instant messaging information, the receiver client 504 may further determine whether it stores the operation information relating the second user identification to the first user identification at local memory, and display the instant messaging information if the result of determination is positive, or filter the instant messaging information if the result is negative.

The sender client and the receiver client in the third example embodiment may be the sender client and the receiver client in the first example embodiment and the second example embodiment. The server is a network device that is capable of performing the operations in the first example embodiment and the second example embodiment.

The following illustrates the fourth example embodiment.

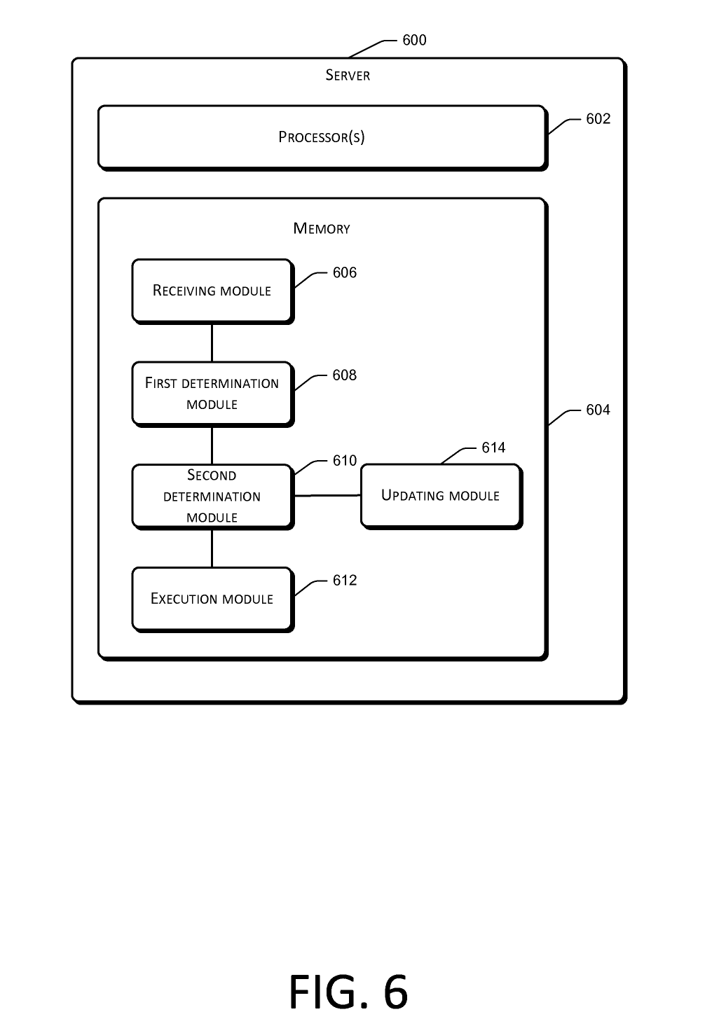

FIG. 6 illustrates an example server 600 for transmitting instant messaging information in accordance with the fourth example embodiment of the present disclosure.

In one example, the server 600 can include, but is not limited to, one or more processors 602 and memory 604. The memory 604 may include computer-readable media in the form of volatile memory, such as random-access memory (RAM) and/or non-volatile memory, such as read only memory (ROM) or flash RAM. The memory 604 is an example of computer-readable media.

Computer-readable media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 604 may store therein program units or modules and program data. In one embodiment, the modules may include a receiving module 606, a first determination module 608, a second determination module 610 and an execution module 612. In another embodiment, the modules may further include an updating module 614.

These modules may therefore be implemented in software that can be executed by the one or more processors 602. In other implementations, the modules may be implemented in firmware, hardware, software, or a combination thereof.

The receiving module 606 receives the instant messaging information including a first user identification of a sender and a second user identification of a receiver. The first determination module 608 determines whether the first user identification is a high priority user identification of the second user identification, and triggers the second determination module if a result of the determination is negative. The second determination module 610 determines whether operation information relating the second user identification to the first user identification is stored. The execution module 612 determines whether to filter the instant messaging information according to a result of the second determination module.

When it is determined that the operation information is stored, the execution module 612 sends the instant messaging information to a client corresponding to the second user identification and instructs the client to display the instant messaging information. Otherwise, the execution module 612 sends the instant messaging information to a client corresponding to the second user identification, and instructs the client to filter the instant messaging information.

The updating module 614 invalidates, expires, or deletes the operation information when the operation information includes the operation time and the valid period and the operation information passes the valid period starting from the operation time.

In another embodiment, the second determination module 610 may further determine whether the operation information is expired when the operation information is stored. When it is determined that the operation information is expired, the execution module 612 sends the instant messaging information to the client corresponding to the second user identification, and instructs the client to filter the instant messaging information. Otherwise, the execution module 612 sends the instant messaging information to a client corresponding to the second user identification, and instructs the client to filter the instant messaging information.

The server in the fourth example embodiment may also include one or more function modules to perform the operations in the first example embodiment and the second example embodiment.

One of ordinary skill in the art would understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

The present disclosure is described by referring to the flow charts and/or block diagrams of the method, equipment (system) and computer program of the embodiments of the present disclosure. It should be understood that each flow and/or block and the combination of the flow and/or block of the flowchart and/or block diagram can be implemented by computer-executable instructions. These computer-executable instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be saved in other computer-readable media which can instruct a computer or other programmable data processors to operate in a certain way, so that the instructions saved in the computer-readable storage generate a product containing the instruction device, wherein the instruction device implements the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

Above are exemplary embodiments of the present disclosure. However, the present disclosure is not limited hereto. It is appreciated that one of ordinary skill in the art can alter or modify the present disclosure in many different ways without departing from the spirit and the scope of this disclosure. These modifications and variations should therefore be considered to fall within the scope of the claims of the present disclosure and their equivalents.

1. A method of transmitting instant messaging information, performed by one or more processors configured with computer-executable instructions, comprising:
receiving instant messaging information including a first user identification of a sender and a second user identification of a receiver;
determining whether the first user identification is of a user associated with the second user identification;
in an event that the first user identification is not of a user associated with the second user identification user, determining whether operation information relating the second user identification to the first user identification exists; and
electing whether to filter the instant messaging information based at least in part on whether the operation information exists.

2. The method as recited in claim 1, further comprising, in an event that the first user identification is of a user associated with the second user identification, sending the instant messaging information to the receiver for presentation.

3. The method as recited in claim 1, wherein the operation information comprises information representing indirect operation from the second user identification to the first user identification.

4. The method as recited in claim 1, wherein the operation information comprises an operation time and a valid period, and the method further comprises invalidating or deleting the operation information when the operation information passes the valid period from the operation time.

5. The method as recited in claim 1, wherein the operation information comprises at least one of:
visiting record information of the second user identification visiting a document corresponding to the first user identification; and
transaction record information between the second user identification and the first user identification.

6. The method as recited in claim 5, wherein the document comprises a web page.

7. The method as recited in claim 1, wherein the electing whether to filter the instant messaging information comprises:
in an event that the operation information exists, sending the instant messaging information to the receiver for presentation; and
in an event that the operation information does not exist, sending the instant messaging information to the receiver together with instructions to filter the instant messaging information.

8. The method as recited in claim 7, further comprising:
in an event that the operation information exists, determining whether the operation information expires;
sending the instant messaging information together with an instruction to filter the instant messaging information if the operation information has expired; and
sending the instant messaging information on to the receiver for presentation if the operation information has not expired.

9. The method as recited in claim 8, further comprising, after sending the instant messaging information together with the filter instruction,
determining whether the operation information is stored at a receiver client associated with the receiver;
presenting the instant messaging information at the receiver client if the operation information is stored at the receiver client; and
filtering the instant messaging information at the receiver client if the operation information is not stored at the receiver client.

10. The method as recited in claim 9, further comprising storing operation information at a server remote from the receiver client following presentation of the instant messaging information at the receiver client.

11. The method as recited in claim 1, wherein the instant messaging information includes information containing texts and pictures, information enclosing documents, or a request for conducting communications with the receiver.

12. A server for transmitting instant messaging information, comprising:
a receiving module that receives instant messaging information, the instant messaging information including a first user identification of a sender and a second user identification of a receiver;
first and second determination modules, the first determination module to determine whether the first user identification is an identification of a high priority user of the second user identification, and to trigger the second determination module in response to a result that the first user identification is not the identification of the high priority user of the second user identification, the second determination module to determine whether operation information relating the second user identification to the first user identification is stored; and
an execution module to determine whether to filter the instant messaging information at least partly based on a result of the second determination module.

13. The server as recited in claim 12, wherein the operation information comprises an operation time and a valid period, and the server further comprises an updating module that invalidates or deletes the operation information when the operation information passes the valid period from the operation time.

14. (canceled)

15. The server as recited in claim 12, wherein the second determination module further determines whether the stored operation information is valid.

16. The server as recited in claim 15, wherein the execution module sends the instant messaging information and a filtering instruction to a receiver client associated with the second user identification in response to a result from the second determination module that the operation information is invalid.

17. The server as recited in claim 15, wherein the execution module sends the instant messaging information and a display instruction to a receiver client associated with the second user identification in response to a result from the second determination module that the operation information is valid.

18. A system of transmitting instant messaging information, comprising:
a server that receives instant messaging information sent by a sender client relating to a first user identification of a sender and intended for a receiver client related to a second user identification of a receiver, and determines whether the instant messaging information should be filtered based on (1) whether the first user identification is an identification of a high priority user of the second user identification and (2) whether the operation information relating the second user identification to the first user identification is stored.

19. The system as recited in claim 18, wherein the server, upon determining affirmatively that either (1) the first user identification is an identification of a high priority user of the second user identification or (2) the operation information relating the second user identification to the first user identification is stored, sends a presentation instruction to the receiver client to display the instant messaging information.

20. The system as recited in claim 18, further comprising:
a receiver client;
the server, upon determining that either (1) the first user identification is not an identification of a high priority user of the second user identification or (2) the operation information relating the second user identification to the first user identification is not stored, sends a filtering instruction to the receiver client; and
the receiver client further configured to determine whether the operation information is stored at the receiver client and to one of filter the instant messaging information in response to a determination that the operation information is not stored at the receiver client or display the instant messaging information in response to a determination that the operation information is stored at the receiver client.

21. The server as recited in claim 12, wherein the execution module sends the instant messaging information and a presentation instruction to a receiver client associated with the second user identification in response to a result from the second determination module that the operation information is stored at the server, and sends the instant messaging information and a filtering instruction to a receiver client associated with the second user identification in response to a result from the second determination module that the operation information is not stored at the server.
